(19) United States
(12) Patent Application Publication
(10) Pub. No.: US 2020/0394384 A1
(43) Pub. Date: Dec. 17, 2020

(54) Real-time Aerial Suspicious Analysis (ASANA) System and Method for Identification of Suspicious individuals in public areas

(71) Applicant: AMARJOT SINGH, BURLINGAME, CA (US)

(72) Inventor: AMARJOT SINGH, BURLINGAME, CA (US)

(21) Appl. No.: 16/895,515

(22) Filed: Jun. 8, 2020

Related U.S. Application Data
(60) Provisional application No. 62/861,326, filed on Jun. 14, 2019.

(51) Int. Cl. G06K 9/00; G06K 9/62; G06T 7/70; G06K 9/46

(52) U.S. Cl. CPC G06K 9/0063; G06K 9/628; G06T 7/70; H04L 67/10; G06K 9/46; G06K 9/00335; G06K 9/00771; G06K 9/00362

(57) ABSTRACT

A real-time aerial suspicious analysis (ASANA) system and method for identifying individuals engaged in suspicious activities in public areas is provided in the present invention. The aerial suspicious analysis (ASANA) uses a Drone for constant capturing and recording images/videos, and/or can be activated to capture/record based on a specific schedule and/or event; a YOLO detector to detect the individuals; a SHDL network for individual pose estimation, and then classification is performed of the estimated pose to identify the suspicious/violent individuals.

### CROSS REFERENCE TO RELATED APPLICATIONS

This application claims priority on U.S. Provisional Patent Application No. 62/861,326, entitled “Real-time Aerial Suspicious Analysis (ASANA) System for the Identification of Suspicious Individuals in public areas”, filed on Jun. 14, 2019, which is incorporated by reference herein in its entirety and for all purposes.

### FIELD OF THE INVENTION

The present invention relates to a real-time aerial suspicious analysis (ASANA) system and method to identify suspicious individuals or events related to suspicious individuals in public areas. More particularly, the invention relates to the identification of individuals involved in carrying objects of interest or weapons engaging in suspicious activities/criminal activities such as riots, theft etc. using the ScatterNet Hybrid Deep Learning Network.

### BACKGROUND

In recent years, the rate of criminal activities and abnormal events by individuals and terrorist groups has been on the rise. The economic and social life has suffered due to these events and the safety and security of the public has become a major priority. The law enforcement agencies have been motivated to use video safety and security systems to monitor and curb these threats. Many automated video safety and security systems have been developed in the past to monitor abandoned objects (bags), theft, fire or smoke, violent activities, etc.

There are some safety and security systems available to monitor and curb these threats which are known, for examples U.S. patent application Ser. No. 15/894,214 discloses a method for detection of objects in the images. The method includes extracting a plurality of image frames received from one or more imaging devices, selecting at least one image frame from the plurality of image frames and then the selected image frame is analysed to determine the presence of one or more objects. The objects are analyzed using the intensity of pixels in the selected image frame to determine if any of the objects is an anomaly. After that, a notification is created upon determining the anomaly is present in the selected image frame, where the notification can indicate that the imaged object is suspicious.

U.S. patent application Ser. No. 15/492,010 discloses a video security system and method for monitoring active environments that can detect and track objects that produce a security-relevant breach of a virtual perimeter. This system detects suspicious activities such as loitering and parking, and provides fast and accurate alerts.

Chinese patent application CN109002783A discloses a human detection and gesture recognition method in the rescue environment; the method is based on the real-time analysis of images acquired by the camera at rescue environment.

Chinese patent application CN108564022A discloses a multi-person posture detection method based on a positioning classification regression network. The method includes positioning, classification, regression and iterative estimation. The detection method is based on multi-character gesture classification and regression positioning network which first locates hypothetic posture categories in the candidate set of boxes (represented as an anchor point posture) to obtain posture suggestions. A classifier is used to score each posture suggestion by calculating anchor posture specific regression, and thereafter the posture estimation is obtained by performing integration on adjacent posture hypotheses.

Chinese patent application CN107564062A discloses a pose abnormality detecting system method. The method includes acquiring an initial image from which the system obtains the initial reference frame, and then obtains the initial position and orientation of the camera. The method computes a difference value between the detected camera pose frame and the initial position and orientation of the original reference frame and determining whether the difference value is greater than a predetermined threshold value, and if the difference value is greater than the preset threshold, the detected posture abnormality alarm is set off. It determines whether the detected camera pose changes abnormality has occurred. The camera pose estimation refers to estimating both the camera position and orientation.

Li et al. discloses a video surveillance system to identify the abandoned objects with the use of Gaussian mixture models and Support Vector Machine. This system is robust to illumination changes and performs with an accuracy of 84.44%. This system has proven vital for the detection of abandon bags in busy public areas, which may contain bombs.

Chuang et al. discloses forward-backward ratio histogram and a finite state machine to recognize robberies. This system has proven to be very useful around automatic teller machines (ATMs) and has detected 96% cases of the theft.

Seebamrungsat et al. discloses a fire detection system based on HSV and YCbCr color models as it allowed it to distinguish bright images more efficiently than other RGB models. The system has been shown to detect fire with an accuracy of more than 90.0%.

Goya et al. discloses a Public Safety System (PSS) for identifying criminal actions such as purse snatching, child kidnapping, and fighting using distance, velocity, and area to determine the human behaviour. This system can identify the criminal actions with an accuracy of around 85%.

These systems have been very successful in detecting and reporting various criminal activities. Despite their impressive performance (more than 90% accuracy), the area these systems can monitor is limited due to the restricted field of view of the cameras. The law enforcement agencies have been motivated to use aerial surveillance systems to surveil large areas. Governments have recently deployed drones in war zones to monitor hostiles, to spy on foreign drug cartels, conducting border control operations as well as finding criminal activity in urban and rural areas.

Surya et al. discloses an autonomous drone surveillance system capable of detecting individuals engaged in violent activities in public areas. This is a system that used the deformable parts model to estimate human poses which are then used to identify suspicious individuals.

This is an extremely challenging task as the images or videos recorded by the drone can suffer from illumination changes, shadows, poor resolution, and blurring. Also, the humans can appear at different locations, orientations, and scales. Despite the above-explained complications, the system can detect violent activities with an accuracy of around 76% which is far less as compared to the greater than 90% performance of the ground surveillance systems.

The prior art is not yet able to accurately identify the abnormal behaviour of such individuals and identification of individuals involved in carrying objects of interest or weapons engaging in suspicious activities/criminal activities such as riots, theft etc., in the crowd at public areas.

Therefore, there is a need for an improved real-time aerial suspicious analysis (ASANA) system and method to identify suspicious individuals by recognising poses of an individual in public areas. In which individual poses are detected from the captured aerial video sequence and identify violent individuals. The technology can effectively prevent violent attacks, stampede, and other emergencies; and provide timely warnings for real-time monitoring of anomalies so that timely appropriate action can be taken to curb these activities.

### SUMMARY OF THE INVENTION

The present invention provides a real-time aerial suspicious analysis (ASANA) system that can detect one or more individuals engaged in suspicious activities from aerial images.

In one aspect, the aerial suspicious analysis (ASANA) system is computed on the processing device and is configured to perform following steps: (i) detecting individuals using a YOLO (you only look once) detector, (ii) Individual pose estimation using a ScatterNet Hybrid Deep Learning (SHDL) network, and (iii) classification of the estimated pose. The processing device is build with the form of a cloud service, local server, custom silicon, gate array processor, general computing CPU or GPU.

In one aspect of the present invention provides a real-time aerial suspicious analysis (ASANA) system for identifying suspicious individuals in public areas or in a controlled environment, the system includes at least one drone configured for capturing/recording one or more aerial images; at least one computing system for performing analysis on the aerial images for extracting features from the captured/recorded image; a YOLO detector for detecting the individuals; a ScatterNet Hybrid Deep Learning (SHDL) Network for pose estimation of the detected individuals, where the ScatterNet Hybrid Deep Learning (SHDL) Network identifies fourteen key-points of a human body to form a skeleton structure of the detected individuals; and a three dimensional (3D) ResNet for classification to determine whether anomalies/suspicious individuals exist in the estimated pose. The ScatterNet Hybrid Deep Learning (SHDL) Network is trained with an Aerial Violent Individual (AVI) Dataset to perform analysis of the identified key-points, where the Aerial Violent Individual (AVI) Dataset is composed of thousands of images and thousands of individuals engaged in one or more suspicious or violent activities.

In one more aspect of the present invention provides monitoring such as but limited to criminal activities, abnormal events or incidents by the individuals.

In one more aspect of the present invention, the drone is further configured to monitor a coverage area to detect incidents occurring within and/or approximate to the coverage area and respond to these incidents.

In one more aspect of the present invention, the drone is configured to perform constant capturing/recording, and/or can be activated to capture/record based on a specific schedule and/or event.

The aerial suspicious analysis (ASANA) system uses the YOLO detector first to detect the individuals, the ScatterNet Hybrid Deep Learning (SHDL) network for individual pose estimation, and then the orientations of the limbs of the estimated pose are used to identify suspicious individuals using the 3D ResNet (residual neural network). Preferably, 3D ResNet identifies the posture as one of the violent poses from the dataset and flags the individuals engaged as violent or suspicious.

In one aspect, the system first uses the YOLO detector to detect individuals after which the proposed ScatterNet Hybrid Deep Learning (SHDL) network is used to estimate the pose of the individuals. The estimated poses are used by the 3D ResNet (residual neural network) to identify suspicious individuals.

In another aspect of the present invention, the 3D ResNet classifies the individuals as either neutral or assigns a most likely suspicious or violent activity label using the estimated poses.

The aerial suspicious analysis (ASANA) system of the present invention is to identify suspicious individuals/humans in public areas using one or more drones. For the safety and security, the drone is configured with a processing device for onboard processing or a cloud server is used to perform computations in real-time, in which a YOLO detector is used to detect individuals from the images recorded by the drone and then a ScatterNet Hybrid Deep Learning (SHDL) Network performs the individual pose estimation.

In another aspect of the present invention, the aerial suspicious analysis (ASANA) system is preconfigured with an Aerial Violent Individual (AVI) Dataset. The AVI dataset contains images with individuals recorded at different variations of scale, position, illumination, blurriness, etc. The complete datasets consist of thousands of individuals engaged in one or more of the violent activities such as but not limited to Punching, Stabbing, Shooting, Kicking, Strangling Pushing, Shoving, Grabbing, Slapping, Physically assaulting, Hitting etc.

Further, each individual in the aerial image frame is annotated with several key-points which are utilized by the proposed ScatterNet Hybrid Deep Learning (SHDL) network as labels for learning pose estimation. The system further includes a regression network (RN) that also uses structural priors to expedite the training as well as reduce the dependence on the annotated datasets. The system further includes 3D ResNet (residual neural network) that classifies the individuals as either neutral or assigns the most likely suspicious or violent activity label using the vector of orientations obtained for the estimated human pose.

In another aspect, 14 key-points are annotated on the human body as Facial Region (P1—Head, P2—Neck); Arms Region (P3—Right shoulder, P4—Right Elbow, P5—Right Wrist, P6—Left Shoulder, P7—Left Elbow, P8—Left Wrist) and Legs Region (P9—Right Hip, P10—Right Knee, P11—Right Ankle, P12—Left Hip, P13—Left Knee, P14—Left Ankle).

In another aspect of the present invention provides a method for identifying suspicious or violent individuals in public areas or in a controlled environment in real time, the method includes capturing/recording one or more aerial images using one or more drones; detecting individuals using a YOLO detector by performing analysis on the aerial images for extracting features from the captured/recorded image; pose estimation of the individuals using a ScatterNet Hybrid Deep Learning (SHDL) Network to determine whether anomalies exist in the captured/recorded images; identifying fourteen key-points of a human body to form a skeleton structure of the detected individuals; and classifying of the estimated pose using a three dimensional (3D) ResNet, wherein the ScatterNet Hybrid Deep Learning (SHDL) Network is trained with an Aerial Violent Individual (AVI) Dataset to perform analysis of the identified key-points, where the Aerial Violent Individual (AVI) Dataset is composed of thousands of images and thousands of individuals engaged in one or more suspicious or violent activities and the 3D ResNet determines whether anomalies/suspicious individuals exist in the estimated pose.

One advantage of the present invention is used in detecting individuals engaged in violent/suspicious activities in public areas or large gatherings.

### BRIEF DESCRIPTION OF THE DRAWINGS

The object of the invention may be understood in more details and more particularly description of the invention briefly summarized above by reference to certain embodiments thereof which are illustrated in the appended drawings, which drawings form a part of this specification. It is to be noted, however, that the appended drawings illustrate preferred embodiments of the invention and are therefore not to be considered limiting of its scope, for the invention may admit to other equally effective equivalent embodiments.

FIG. 1 illustrates an exemplary Aerial Suspicious Analysis (ASANA) system in accordance with the present invention;

FIG. 2 illustrates the several key-points annotated on the human body in accordance with the present invention;

FIG. 3a illustrates a pose estimation performance via the detection of key-points in accordance with the present invention;

FIG. 3b illustrates another pose estimation performance via the detection of key-points in accordance with the present invention;

FIG. 3c illustrates another pose estimation performance via the detection of key-points in accordance with the present invention; and

FIG. 4 is a flowchart illustrating an exemplary method of identifying violent individuals using the Aerial Suspicious Analysis (ASANA) in accordance with the present invention.

### DETAILED DESCRIPTION OF THE INVENTION

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

For understanding of the person skilled in the art, the term “suspicious or violent individuals/humans” as used herein refers to the person engaged in one or more of the violent activities such as but not limited to Punching, Stabbing, Shooting, Kicking, Strangling Pushing, Shoving, Grabbing, Slapping, Physically assaulting, Hitting etc.

As described herein with several embodiments, the present provides a real-time Aerial Suspicious Analysis (ASANA) to identify suspicious or violent individuals/humans in public areas. In some embodiments, the present invention provides the Aerial Suspicious Analysis (ASANA) system for monitoring criminal activities and abnormal events or incidents by the individuals.

In one embodiment, the present invention provides the Aerial Suspicious Analysis (ASANA) system with one or more drones that is configured to monitor a coverage area to detect incidents occurring within and/or approximate to the coverage area and respond to these incidents.

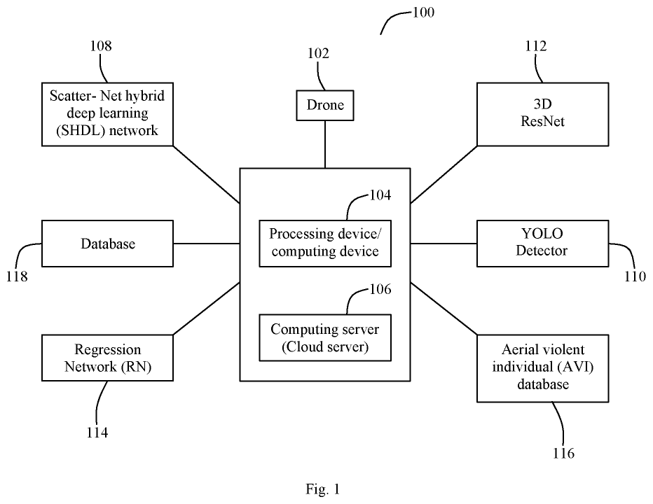

In an exemplary preferred embodiment, as shown in FIG. 1, the present invention provides an Aerial Suspicious Analysis (ASANA) system 100 to identify suspicious or violent individuals/humans in public areas. As shown in FIG. 1, the Aerial Suspicious Analysis (ASANA) system includes a drone 102 configured with a processing unit 104, a computing server (cloud server) 106, a ScatterNet Hybrid Deep Learning (SHDL) Network (SHDL) 108, YOLO detector 110, a 3D ResNet 112, a regression network (RN) 114, an aerial Violent Individual (AVI) Dataset 116 and database 118.

In one embodiment, the cloud server 106 performs computing functions in real-time, whereas the cloud server 106 is configured with the YOLO detector 110 to detect individuals from the images recorded by the drone 102 and the individual pose is estimated using the ScatterNet Hybrid Deep Learning (SHDL) Network 108. The Aerial Suspicious Analysis (ASANA) system 100 is preconfigured with Aerial Violent Individual (AVI) Dataset 116. The AVI dataset 116 contains images with individuals recorded at different variations of scale, position, illumination, blurriness, etc. This AVI dataset 116 is used by the ScatterNet Hybrid Deep Learning (SHDL) network 108 to learn pose estimation. The AVI dataset 116 is composed of thousands of images, where each image contains at least two individuals. The complete datasets consist of thousands of individuals engaged in one or more of the suspicious or violent activities such as but not limited to Punching, Stabbing, Shooting, Kicking, Strangling Pushing, Shoving, Grabbing, Slapping, Physically assaulting, Hitting etc. Further, each individual in the aerial image frame is annotated with at least 14 key-points which are utilized by the proposed SHDL network 108 as labels for learning pose estimation. The Aerial Suspicious Analysis (ASANA) system 100 further includes the regression network (RN) 114 also uses structural priors to expedite the training as well as reduce the dependency on the annotated datasets. The Aerial Suspicious Analysis (ASANA) system 100 further includes a 3D ResNet 112 that classifies the individuals as either neutral or assigns the most likely suspicious or violent activity label trained using the vector of orientations computed using the estimated human poses.

In another embodiment of the present invention, the Drone 102 is used for recording the images. The Drone 102 used in the present invention is such as but not limited to a Parrot AR Drone that consists of two cameras, an Inertial Measurement Unit (IMU) including a 3-axis accelerometer, 3-axis gyroscope and 3-axis magnetometer, and ultrasound and pressure-based altitude sensors. Other features include at least 1 GHz ARM Cortex-A8 as the CPU and run a Linux operating system. In some embodiments, the front-facing camera has a resolution of 1280×720 at 30 fps with a diagonal field of view of 92° while the downward facing camera is of the lower resolution of 320×240 at 60 fps with a diagonal field of view of 64°. The frames per second (fps) can vary depending upon the hardware configuration of the system. The front facing camera is used to record the images due to its higher resolution. The downward facing camera estimates the parameters determining the state of the drone such as roll, pitch, yaw, and altitude using the sensors onboard to measure the horizontal velocity. The horizontal velocity calculation is based on an optical flow-based feature. All the sensor measurements are updated at the 200 Hz rate. The images recorded by drone 102 are transferred to a processing system 104 to achieve real-time identification. The selection is provided to facilitate an understanding for the person skilled in the art and is not in any way limiting.

In some implementations, the limbs of the skeleton are given as input to a 3D ResNet 112 which classifies the individuals as either neutral or assigns the most likely violent activity label. As used herein, the Aerial Suspicious Analysis (ASANA) system 100 is used to identify the individuals engaged in violent activities from the aerial images.

In another embodiment, the Aerial Suspicious Analysis (ASANA) system 100 uses a pose estimation method and activity classification method to identify the individuals. The Aerial Suspicious Analysis (ASANA) system 100 uses the ScatterNet Hybrid Deep Learning (SHDL) Network 108 for human pose estimation. The SHDL network 108 for pose estimation is composed of a hand-crafted ScatterNet front-end and a supervised learning based back-end formed of the modified coarse-to-fine deep regression network (RN) 114. The SHDL network 108 is constructed by replacing the first convolutional, relu and pooling layers of the coarse-to fine deep regression network (RN) 114 with the hand-crafted parametric log ScatterNet. This accelerates the learning of the regression network (RN) 114 as the Scatter-Net front-end extracts invariant (translation, rotation, and scale) edge features which can be directly used to learn more complex patterns from the start of learning. The invariant edge features can be beneficial for identification as the humans can appear with these variations in the aerial images.

Further in some embodiments, various other neural networks, deep learning systems, etc., can be used for the identification of violent activities and violent individuals. The computing system/processing system 104 can identify the persons of interest in real-time. In some implementations, the computing server 104 can be configured to access database(s) 118 to obtain any requisite information that may be required for its analysis.

In another embodiment, the Aerial Suspicious Analysis (ASANA) system 100 performs the computation and memory demanding SHDL network 108 processes along with the activity classification technique on the processing system 104 while keeping short-term navigation onboard. This allows the system 100 to identify the individuals of interest in real-time.

In a preferred embodiment, the Aerial Suspicious Analysis (ASANA) system 100 captures images of the individuals and identifies the violent individual in the plurality of the images captured.

Further in some embodiments, the SHDL network 108 is trained with the Aerial Violent Individual (AVI) Dataset 116. The AVI dataset 116 contains images with humans recorded at different variations of scale, position, illumination, blurriness, etc. This AVI dataset 116 is used by the SHDL network 108 to learn pose estimation. The AVI dataset 116 is composed of thousands of images, where each image contains at least two individuals. The complete datasets consist of thousands of individuals engaged in one or more of the suspicious or violent activities such as but not limited to Punching, Stabbing, Shooting, Kicking, Strangling Pushing, Shoving, Grabbing, Slapping, Physically assaulting, Hitting etc.

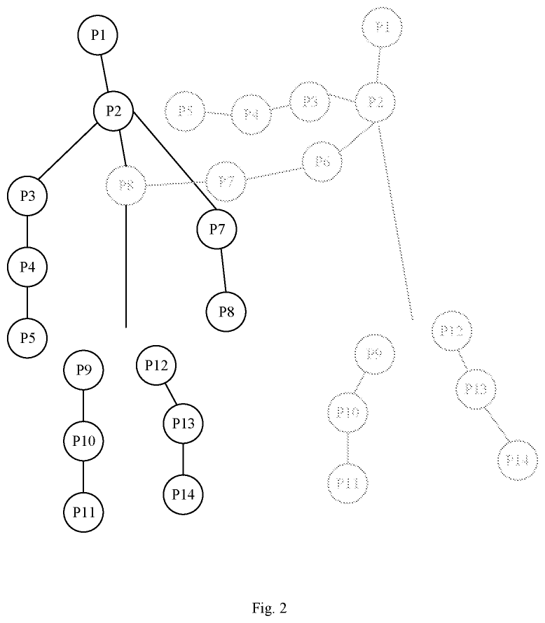

Further in another embodiment, each individual in the aerial image frame is annotated with several (in this example 14) key-points which are utilized by the proposed network as labels for learning pose estimation as shown in FIG. 2. In an exemplary embodiment, 14 key-points are utilized by the proposed invention without limiting the scope of the present invention.

In another embodiment as shown in the FIG. 2, the proposed invention provides 14 key-points annotated on the human body. In some embodiment, the Facial Region includes P1—Head and P2—Neck; the Arms Region includes P3—Right shoulder, P4—Right Elbow, P5—Right Wrist, P6—Left Shoulder, P7—Left Elbow and P8—Left Wrist; and the Legs Region includes P9—Right Hip, P10—Right Knee, P11—Right Ankle, P12—Left Hip, P13—Left Knee, and P14—Left Ankle.

In another embodiment, the proposed Aerial Violent Individual (AVI) Dataset 116 includes images with the above-detailed variations as these can significantly alter the appearance of the individuals and affect the performance of the surveillance system. In another embodiment, the SHDL network 108, when trained on the AVI dataset 116 with these variations, can learn to recognize human poses despite these variations.

In another embodiment of the present invention, the Aerial Suspicious Analysis (ASANA) system 100 first uses the YOLO Network 110 to detect individuals from the images recorded by the Drone 102, then the ScatterNet Hybrid Deep Learning (SHDL) Network 108 is used to estimate the pose of each detected individual and finally, the estimated poses are used by the 3D ResNet 112 to identify the violent individuals.

In one exemplary embodiment, the ScatterNet Hybrid Deep Learning (SHDL) Network 108 identifies the several (in this example 14 key-points) key-points on the body of the identified individuals that are connected to form a skeleton structure as shown in FIG. 2. Further, the 3D ResNet 112 is trained on the estimated skeletons for at least five suspicious or violent activities (Punching, Stabbing, Shooting, Kicking, and Strangling) and one neutral activity to perform multi-class classification. In another embodiment, the system further uses one or more violent activities but not limited to violent activities such as Punching, Stabbing, Shooting, Kicking, Strangling Pushing, Shoving, Grabbing, Slapping, Physically assaulting, Hitting etc.

In another embodiment, the 3d ResNet 112 classifies the individuals as either neutral or assigns the most likely suspicious or violent activity label.

In another embodiment, the system 100 is configured with a processing system 104 to achieve the identification of the individuals in real-time.

As discussed herein, the system 100 makes use of the YOLO detector 110 to detect individuals quickly from the images recorded by the drone 102. The YOLO detector 110 uses a single neural network that is applied on the complete image. This network divides the image into regions and predicts bounding boxes and probabilities for each region. These bounding boxes are weighted by predicted probabilities to detect humans.

In another embodiment, the YOLO detector 110 is pre-trained on the various categories detection dataset and can detect individuals recorded by the Drone 102 with an accuracy of 97.2%.

In another embodiment, the ScatterNet accelerates the learning of the SHDL network 106 by extracting invariant edge-based features which allow the SHDL network 108 to learn complex features from the start of the learning. In some embodiments, the regression network (RN) 114 also uses structural priors to expedite the training as well as reduce the dependence on the annotated datasets.

In another embodiment, the ScatterNet at front-end and regression network (RN) 112 at back-end parts of the proposed SHDL network 106 are described herein in detail. The ScatterNet (front-end) is the parametric log based DTCWT ScatterNet which is an improved numerous versions of the hand-crafted multi-layer Scattering Networks. The parametric log Scatter-Net extracts relatively symmetric translation invariant representations using the dual-tree complex wavelet transform (DTCWT) and parametric log transformation layer. The ScatterNet features are denser over scale as they are extracted from multi-resolution images at 1.5 times and twice the size of the input image.

The image regions detected by the YOLO detector 110 are resized to 120×80 and normalized by subtracting the image regions mean and dividing by its standard deviation.

### Result 1:

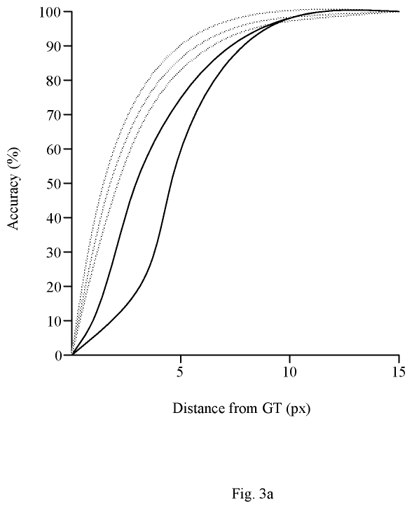

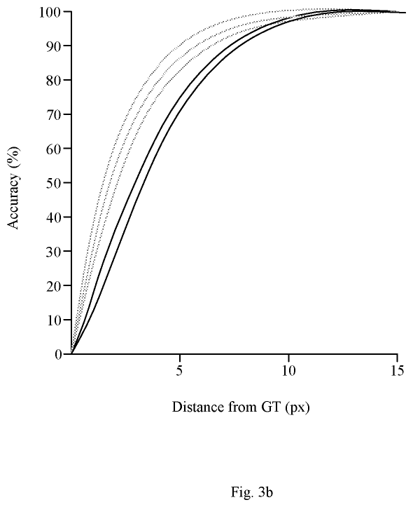

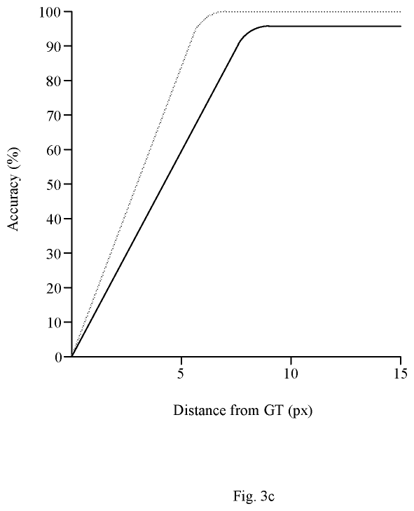

In one exemplary embodiment, as shown in FIGS. 3a, 3b and 3c, the pose estimation performance of the SHDL network 108 is evaluated by comparing the coordinates of the detected (in this example 14 key-points) key-points with their ground truth (GT) values on the annotated dataset. The key-points are deemed correctly located if it is within a set distance of d pixels from a marked key-point in the ground truth (GT) via the accuracy vs. distance graphs, for different regions of the body. The key-points detection analysis for the arms, legs, and facial, regions is presented below.

The arm region constitutes six points namely: wrist key-points (P5 and P8), shoulder key-points (P3 and P6), and elbow key-points (P4 and P7), as shown in FIG. 2. FIG. 3a indicates that the SHDL network 108 can detect the wrist region key-points with an accuracy of around 60%, for a pixel distance of d=5. The detection accuracy is much higher for the elbow and shoulder region at roughly 85% and 95% respectively, for the same pixel distance (d=5). Legs Region: The leg region constitutes six key-points, namely: hip key-points (P9, P12), knee key-points (P10, P13), and ankle key-points (P11, P14), as shown in FIG. 2. FIG. 3b indicates that the SHDL network detects hip key points with almost 100% for a pixel distance of d=5. The detection accuracy is between 85% and 90% for the knee key-points while the detection rate falls to around 85% for the ankle key-points. The facial region constitutes two points, one the head (P1) and the other on the neck (P2), as shown in FIG. 2. The algorithm detects the neck key-point (P2) more accurately as compared the head key-point (P1) with an accuracy of around 95% as opposed to roughly 77% accuracy, for a pixel distance of d=5, as shown in FIG. 3c.

The human pose estimation performance of the SHDL network 108 on the Aerial Violent Individual (AVI) dataset 116 is presented in Table 1. As observed from the Table, the SHDL network 108 estimates the human pose based on the (in this example 14 key-points) key-points at d=5 pixel distance from the ground-truth, with 87.6% accuracy.

TABLE 1
Comparison of the human pose estimation performance of
SHDL network 108 with Coordinate network (CN), Coordinate
extended network (CNE) and Spatial network based on the
detection of the (14) key-points. The evaluation is presented
on the AVI dataset 116 for maximum 5 pixels allowed distance
(d=5) from the annotated ground truth.

Deep Learning Networks

| Dataset | SHDL | CN | CNE | Spatial Net |
|---|---|---|---|---|
| AVI | 87.6 | 79.6 | 80.1 | 83.4 |

Further, the human pose estimation performance of the SHDL network 108 is also compared with several state-of-the-art pose estimation methods; the proposed SHDL network 108 outperforms them by a decent margin.

### Result 2:

In another exemplary embodiment, the detected key-points are connected to form a skeleton structure as shown in FIG. 2. The estimated pose is given as input to the 3D ResNet 112 for pose classification. The classification accuracy on the AVI dataset 116 of each violent activity is presented for 4224 (40%) human poses as shown in Table 2.

TABLE 2
Table presents the classification accuracy (%) for the violent
activities on Aerial Violent Individual (AVI) dataset 116.

| | Violent Activities | | | | |
|---|---|---|---|---|---|
| Dataset | Punching | Kicking | Strangling | Shooting | Stabbing |
| DSS | 89 | 94 | 85 | 82 | 92 |

### Result 3:

The classification accuracy for varying number of human subjects engaged in a violent activity per image is shown in Table 3.

TABLE 3
The table presents the classification accuracies (%) with the increase
in individuals engaged in the violent activities in the aerial
images taken the Aerial Violent Individual (AVI) dataset 116.

| | No. of Violent Individuals (Per Image) | | | | |
|---|---|---|---|---|---|
| Dataset | 1 | 2 | 3 | 4 | 5 |
| DSS | 94.1 | 90.6 | 88.3 | 87.8 | 84.0 |

In some cases the accuracy of the Aerial Suspicious Analysis (ASANA) system 100 decreases with the increase in the number of humans in the aerial image. This can be due to the inability of the YOLO detector 110 to locate all the humans or the incapability of the SHDL network 108 to estimate the pose of the humans accurately. The incorrect pose can result in a wrong orientations vector which can lead the 3D ResNet 112 to classify the activities incorrectly.

The results presented in the above tables are encouraging as the system 100 is more likely to encounter multiple people in an image frame. The classification performance is also compared with the state-of-the-art techniques which were developed to recognize the person of interest from aerial images as shown in Table. 4. The proposed Aerial Suspicious Analysis (ASANA) system 100 is able to outperform the method by more than 10% on the AVI dataset 116.

TABLE 4
The table shows the comparison of the suspicious or
violent individual identification performance of the
proposed system 100 against the prior art technique.

Comparison

| Dataset | ASANA | Prior arts |
|---|---|---|
| AVI | 88.8 | 77.8 |

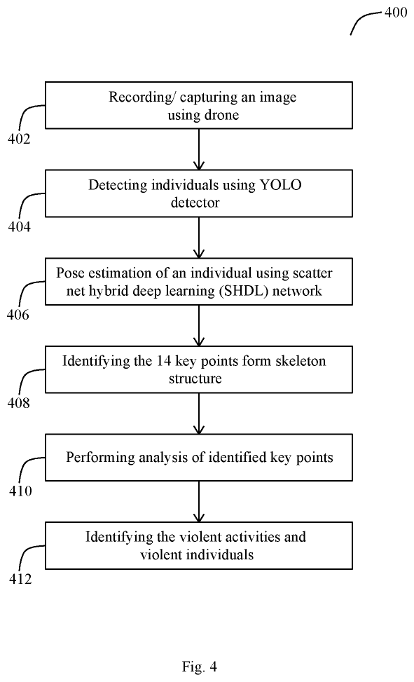

As shown in FIG. 4, in another embodiment, the present invention provides an exemplary method 400 for identifying suspicious or violent individuals/humans in public areas and monitoring criminal activities and abnormal events or incidents by the individuals using the Aerial Suspicious Analysis (ASANA) system 100. According to some implementations of the present invention, the method is described herein with various steps. At step 402, is capturing/recording one or more image(s), video(s), (e.g., a human, a location, etc.) by the Drone 102 camera. The drone 102 can perform constant capturing/recording, and/or can be activated to capture/record based on a specific schedule and/or event then the image(s) are transferred to the computing system 104. At step 404, is performing analysis of captured/recorded image (s) for the purposes of extracting features from the captured/recorded image and, detecting the individuals using YOLO detector 110. At step 406, the detected individuals in the images can be further analyzed to pose estimation of the individuals using ScatterNet Hybrid Deep Learning (SHDL) Network 108 to determine whether anomalies exist in the captured/recorded images. At step 408, is performing 14 key points identification method from skeleton structure, at step 410 is performing the analysis of the identified key points and then finally identifies the violent activities and violent individuals at step 412.

As described above in details, the Aerial Suspicious Analysis (ASANA) system 100 is computed on the processing system and is configured to perform following steps: (i) detecting individuals using the YOLO detector 110, (ii) Individual pose estimation using the SHDL network 108, and (iii) classification of the estimated pose using 3D ResNet 112. In another embodiment, the proposed system 100 is able to detect the violent individuals at 5 fps per second to 16 fps for a maximum of ten and a minimum of two people, respectively, in the aerial image frame. The frames per second (fps) can vary depending upon the hardware/software configuration of the system. Further, in some embodiments, the processing varies depending on the number of individuals within the image frame.

The implementations of the described technology, in which the system is connected with a network server and a computer system capable of executing a computer program to execute the functions. Further, data and program files may be input to the system, which reads the files and executes the programs therein. Some of the elements of a general purpose computer system are a processor having an input/output (I/O) section, a Central Processing Unit (CPU), and a memory.

The described technology is optionally implemented in software devices loaded in memory, stored in a database, and/or communicated via a wired or wireless network link, thereby transforming the computer system into a special purpose machine for implementing the described operations.

The embodiments of the invention described herein are implemented as logical steps in one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

What is claimed is:

1. An aerial suspicious analysis (ASANA) system for identifying suspicious individuals in public areas or in a controlled environment, the system comprising:
at least one drone configured for capturing/recording one or more aerial images;
at least one computing system for performing analysis on the aerial images for extracting features from the captured/recorded image;
a YOLO detector for detecting the individuals by performing analysis on the aerial images for extracting features from the captured/recorded image;
a ScatterNet Hybrid Deep Learning (SHDL) Network for pose estimation of the detected individuals, where the ScatterNet Hybrid Deep Learning (SHDL) Network identifies fourteen key-points of a human body to form a skeleton structure of the detected individuals; and
a three dimensional (3D) ResNet for classification of the estimated pose to determine whether the suspicious individuals exist in the estimated pose,
wherein the ScatterNet Hybrid Deep Learning (SHDL) Network is trained with an Aerial Violent Individual (AVI) Dataset to perform analysis of the identified key-points and the 3D ResNet is trained on the estimated skeletons for at least five suspicious or violent activities (Punching, Stabbing, Shooting, Kicking, and Strangling) and one neutral activity, in the Aerial Violent Individual (AVI) Dataset, to perform multi-class classification
wherein the Aerial Violent Individual (AVI) Dataset is composed of thousands of images and thousands of individuals engaged in one or more suspicious or violent activities.

2. The aerial suspicious analysis (ASANA) system of claim 1, further provides monitoring such as but limited to criminal activities, abnormal events or incidents by the individuals.

3. The aerial suspicious analysis (ASANA) system of claim 1, wherein the drone is further configured to monitor a coverage area to detect incidents occurring within and/or approximate to the coverage area and respond to these incidents.

4. The aerial suspicious analysis (ASANA) system of claim 1, wherein the drone is configured to perform constant capturing/recording, and/or can be activated to capture/record based on a specific schedule and/or event

5. The aerial suspicious analysis (ASANA) system of claim 1, wherein further configured with a processing device for onboard processing or processing on a cloud server to perform computations in real-time for identifying the suspicious individuals.

6. The aerial suspicious analysis (ASANA) system of claim 1, wherein the system is preconfigured with the Aerial Violent Individual (AVI) Dataset or the Aerial Violent Individual (AVI) Dataset is used to train a statistical or a machine learning model for the system.

7. The aerial suspicious analysis (ASANA) system of claim 1, wherein the Aerial Violent Individual (AVI) Dataset includes images with various individuals recorded at different variations of scale, position, illumination, blurriness, etc.

8. The aerial suspicious analysis (ASANA) system of claim 1, wherein the Aerial Violent Individual (AVI) Dataset consist of thousands of individuals engaged in one or more suspicious or violent activities such as but not limited to Punching, Stabbing, Shooting, Kicking, Strangling Pushing, Shoving, Grabbing, Slapping, Physically assaulting, Hitting etc.

9. The aerial suspicious analysis (ASANA) system of claim 1, wherein the ScatterNet Hybrid Deep Learning (SHDL) uses orientations of limbs to estimate the pose of the individuals.

10. The aerial suspicious analysis (ASANA) system of claim 1, wherein the 3D ResNet uses the estimated poses to identify the suspicious individuals.

11. The aerial suspicious analysis (ASANA) system of claims 1 and 10, wherein the 3D ResNet classifies the individuals as either neutral or assigns a most likely suspicious or violent activity label using the estimated poses.

12. The aerial suspicious analysis (ASANA) system of claim 1, wherein the fourteen key-points are annotated on the human body as Facial Region (P1—Head region, P2—Neck), Arms Region (P3—Right shoulder, P4—Right Elbow, P5—Right Wrist, P6—Left Shoulder, P7—Left Elbow, P8—Left Wrist) and Legs Region (P9—Right Hip, P10—Right Knee, P11—Right Ankle, P12—Left Hip, P13—Left Knee, P14—Left Ankle).

13. A method for identifying suspicious individuals in public areas or in a controlled environment, the method comprising:
capturing/recording one or more aerial images using one or more drones;
performing analysis on the aerial images for extracting features from the captured/recorded image;
detecting individuals using a YOLO detector;
pose estimation of the individuals using a ScatterNet Hybrid Deep Learning (SHDL) Network;
identifying fourteen key-points of a human body to form a skeleton structure of the detected individuals; and
classifying of the estimated pose using a three dimensional (3D ResNet for determining whether the suspicious individuals exist in the estimated pose,
wherein the ScatterNet Hybrid Deep Learning (SHDL) Network is trained with an Aerial Violent Individual (AVI) Dataset to perform analysis of the identified key-points, and the 3D ResNet is trained on the estimated skeletons for at least five suspicious or violent activities (Punching, Stabbing, Shooting, Kicking, and Strangling) and one neutral activity, in the Aerial Violent Individual (AVI) Dataset, to perform multi-class classification
wherein the Aerial Violent Individual (AVI) Dataset is composed of thousands of images and thousands of individuals engaged in one or more suspicious or violent activities.

14. The method of claim 13, further includes monitoring such as but limited to criminal activities, abnormal events or incidents by the individuals.

15. The method of claim 13, further includes monitoring a coverage area to detect incidents occurring within and/or approximate to the coverage area and responding to these incidents.

16. The method of claim 13, wherein a processing device for onboard processing or processing on a cloud server for performing computations in real-time for identifying the suspicious individuals.

17. The method of claim 13, wherein includes identifying the suspicious individuals from a Aerial Violent Individual (AVI) Dataset, where the Aerial Violent Individual (AVI) Dataset consist of thousands of individuals engaged in one or more suspicious or violent activities such as but not limited to Punching, Stabbing, Shooting, Kicking, Strangling Pushing, Shoving, Grabbing, Slapping, Physically assaulting, Hitting etc.

18. The method of claim 13, wherein the ScatterNet Hybrid Deep Learning (SHDL) uses orientations of limbs to estimate the pose of the individuals.

19. The method of claim 13, wherein the 3D ResNet uses the estimated poses to identify the suspicious individuals.

20. The method of claim 13, wherein the fourteen key-points are annotated on the human body as Facial Region (P1—Head region, P2—Neck), Arms Region (P3—Right shoulder, P4—Right Elbow, P5—Right Wrist, P6—Left Shoulder, P7—Left Elbow, P8—Left Wrist) and Legs Region (P9—Right Hip, P10—Right Knee, P11—Right Ankle, P12—Left Hip, P13—Left Knee, P14—Left Ankle).
